(19) United States
(12) Patent Application Publication
(10) Pub. No.: US 2006/0251093 A1
(43) Pub. Date: Nov. 9, 2006

(54) Signaling quality of service (QoS) parameters for a multimedia session

(75) Inventors: Igor Curcio, Tampere (FI); Umesh Chandra, Allen, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/416,354

(22) Filed: May 2, 2006

Related U.S. Application Data
(60) Provisional application No. 60/677,283, filed on May 3, 2005.

(51) Int. Cl. H04L 12/56

(52) U.S. Cl. 370/412; 370/252; 370/338

(57) ABSTRACT

Systems and methods enable a receiving device and its wireless network to set up resources optimally and efficiently. A sender device signals some of the negotiated QoS parameters to the receiving device of the session during the session set up procedure. The guaranteed bitrate, maximum bitrate, and transfer delay (which are negotiated along with other QoS parameters during PDP context activation) are signaled to the receiving device. New Session Description Protocol (SDP) attributes are defined for the above-mentioned QoS parameters, which are carried in Session Initiation Protocol (SIP) messages. The receiving device can use these SDP attributes to negotiate (or renegotiate) QoS parameters with its own wireless network during PDP activation. The receiving device can use these parameters to set resources accordingly, such as jitter buffers for audio and video media.

### CROSS REFERENCE TO RELATED APPLICATIONS

This application is a An application claiming the benefit under 35 USC 119(e) US Application 60/677,283, filed May 3, 2005, incorporated herein by reference in its entirety.

### BACKGROUND OF THE INVENTION

1. Field of the Invention

The present invention relates generally to internet protocol (IP) multimedia communication. More specifically, the present invention relates to methods for enhancing and optimizing Quality of Service in IP multimedia communication.

2. Description of the Related Art

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

The 3rd Generation Partnership Project (3GPP) has defined in its technical specification (TS) 23.107 the concept and architecture for Quality of Service (QoS) in 3G mobile communications. QoS determines how the data packets are handled during their transmission in the network. For example, QoS levels determine which packets are buffered, and which packets are dropped during congestion in networks. The QoS levels also determine what bit rates are allocated for media streams. For packet switched communications, Universal Mobile Telecommunication System (UMTS) networks have defined four different types of traffic classes that are also termed as QoS classes (in TS 23.107). These 4 QoS or traffic classes are conversational, streaming, interactive, and background. More details about these traffic types and the different QoS attributes can be found in the 3GPP TS 23.107 document.

When a mobile terminal desires to establish a multimedia call with another party, it activates a Packet Data Protocol (PDP) context with the Gateway GPRS Serving Node (GGSN). In the PDP activation request message, the terminal specifies the QoS attributes it wishes for that session such as the traffic class, maximum bandwidth, guaranteed bandwidth, delay etc. Based on the load of the network and the availability of the resources (at the air-interface and the core network), the network grants the QoS to the mobile terminal.

Different multimedia applications have different properties. For example, applications like video conferencing or audio-conferencing require delivery of the data (video or audio stream) in real or near real-time. These kinds of applications can withstand certain packet losses. However, for applications like database access or web browsing, it is very important that data delivered is as accurate as possible and delay requirements are not very stringent. Based on the application, the user that initiates the session requests for a certain traffic class during PDP context activation. As such, if a user wishes to set up a streaming application, it uses streaming traffic type and for video conferencing application, it uses conversational traffic type. The client application also specifies certain other QoS parameters such as guaranteed bitrate, maximum bitrate, transfer delay etc. that it wants to use for the session for that particular application.

There is no mechanism that lets the sender signal the negotiated QoS parameters end-end to the receiver or the other party in the call. As such, during session set up using SIP/SDP protocol, there is nothing to specify the negotiated QoS parameters to the other party in the call. When the receiver or the called party receives a SIP INVITE message to join the multimedia session, the receiver negotiates the QoS parameters with its own network. The receiver can request a different traffic type class (including incorrect QoS parameters) than the sender had negotiated. Thus, for example, if the sender wanted an interactive or streaming session (e.g., a See What I See (SWIS) application), the receiver could ask for a conversational traffic class. As another example, if the sender specifies a session bandwidth using the bandwidth attribute in the initial SIP INVITE message (for example 64 Kbps) and later when it negotiates with its own wireless network the guaranteed bandwidth QoS parameter, the network can allocate only 48 Kbps to the sender (calling) client. However, the receiver (or the called party) negotiates with its own wireless network for 64 Kbps based on the initial INVITE message from the sender. The receiver's wireless network grants 64 Kbps to the receiver even though the sender sends only at 48 Kbps, resulting in inefficient use of the network resources. If the sender had the capability to signal the negotiated guaranteed bandwidth to the receiver, then the receiver could exactly negotiate the appropriate resources from its own network. Similarly, if the maximum bit rate parameter is not signaled end-to-end, then the receiver terminal can make an incorrect assumption of the maximum bit rate value and can set it as very high or low value. A very high value for maximum bitrate results in an inefficient use of network resources and a very low value for maximum bitrate results in packet losses and produce bad media quality.

FIG. 1 illustrates a simplified signal diagram depicting the foregoing problems resulting when the QoS parameters (Guaranteed and Max bitrate) are not signaled end-to-end. Terminal A interacts with SGSN for PDP context activation and SGSN interacts with GGSN that does the PDP context activation. As illustrated in FIG. 1, the maximum bit rate parameter is not signaled end-to-end. Terminal B, as a result, assumes the maximum bit rate is 72 Kbps and the guaranteed bitrate is 64 Kbps. Terminal A, however, sets the maximum bit rate at 48 Kbps and the guaranteed bitrate at 40 Kbps.

FIG. 2 illustrates scenarios where the sender and the receiver negotiate different types of traffic classes. If the sender (Terminal A) chooses an interactive or streaming traffic type, the receiver can use streaming or conversation traffic class type. The receiver (Terminal B) could also allocate jitter buffer values for conversational (or streaming) traffic class. However, since the sender (Terminal A) has negotiated an interactive or streaming traffic class, which produces higher delay, the receiver buffer underflows because it allocates a jitter buffer for conversational traffic type, which has very stringent delay requirements. This configuration results in bad video quality being displayed at the receiver. As such, even though the client terminal has negotiated the QoS with its respective network, the presented media quality is bad.

Presently, there exists no mechanism where the QoS parameters of an application can be exchanged between the sender and the receiver of the multimedia stream (i.e. the sender and receiver applications). The sender and the receiver only know about the negotiated QoS parameters each has.

Thus, there is a need to signal delay requirements to the other party in a call, such that a receiver can set up its resources (like jitter buffer) based on that and negotiate appropriate QoS parameters from its own network. Further, there is a need to signal QoS parameters (e.g., guaranteed bitrate, maximum bitrate, and granted delay) negotiated by the terminal with the wireless network to the called party in the session.

### SUMMARY OF THE INVENTION

In general, the present invention relates to systems and methods that enable a receiving device and its wireless network to set up resources optimally and efficiently. The guaranteed bitrate, maximum bitrate, and transfer delay (which are negotiated along with other QoS parameters during PDP context activation) are signaled to the receiving device. New Session Description Protocol (SDP) attributes are defined for the above-mentioned QoS parameters, which are carried in Session Initiation Protocol (SIP) messages. The receiving device can use these SDP attributes to negotiate (or renegotiate) QoS parameters with its own wireless network during PDP activation. The receiving device can use these parameters to set resources accordingly, such as jitter buffers for media stream(s) such as audio and video.

One exemplary embodiment relates to a method of signaling quality of service parameters for a multimedia session. The method includes communicating quality of service parameters from a sending device to a receiving device at the creation of a multimedia session, negotiating parameters by the receiving device with a network associated with the receiving device, and communicating quality of service parameters from the receiving device to the sending device during the multimedia session. The negotiated parameters are based on the communicated quality of service parameters from the sending device.

Another exemplary embodiment relates to a system for signaling quality of service parameters for a multimedia session. The system includes means for communicating quality of service parameters from a sending device to a receiving device at the creation of a multimedia session, means for negotiating parameters by the receiving device with a network associated with the receiving device, and means for communicating quality of service parameters from the receiving device to the sending device during the multimedia session. The negotiated parameters are based on the communicated quality of service parameters from the sending device.

Another exemplary embodiment relates to a system for signaling quality of service parameters for a multimedia session. The system includes a sending device and a receiving device. The sending device initiates a multimedia session and communicates quality of service parameters via a communication network. The receiving device receives the communicated quality of service parameters, negotiates parameters with a wireless network associated with the receiving device, and communicates quality of service parameters to the sending device.

Another exemplary embodiment relates to a computer program product utilized in media (e.g. audio and/or video) encoding includes computer code to communicate quality of service parameters from a sending device to a receiving device at the creation of a multimedia session, computer code to negotiate parameters by the receiving device with a network associated with the receiving device, and computer code to communicate quality of service parameters from the receiving device to the sending device during the multimedia session. The negotiated parameters are based on the communicated quality of service parameters from the sending device.

Another exemplary embodiment relates to a device that communicates in multimedia sessions over a network. The device includes memory that stores quality of service parameters which are communicated to a receiving device at a start of a multimedia session, and a processor that receives granted parameters from the receiving device and enables multimedia communication in accordance with the granted parameters.

Another exemplary embodiment relates to a device that communicates in multimedia sessions over a network. The device includes a processor that negotiates parameters with an associated network based on quality of service parameters received from a sending device, and programmed instructions that establish resources based on the quality of service parameters received from the sending device.

### BRIEF DESCRIPTION OF DRAWINGS

FIG. 1 is a diagram illustrating quality of service (QoS) signaling call flow interaction.

FIG. 2 is a diagram illustrating the setting up of incorrect traffic types during a IMS (IP Multimedia Subsystem) multimedia call.

FIGS. 3a and b are diagrams illustrating communication systems in accordance with exemplary embodiments.

FIG. 4 is a diagram illustrating end-to-end signalling of QoS parameters for IMS call setup in accordance with an exemplary embodiment.

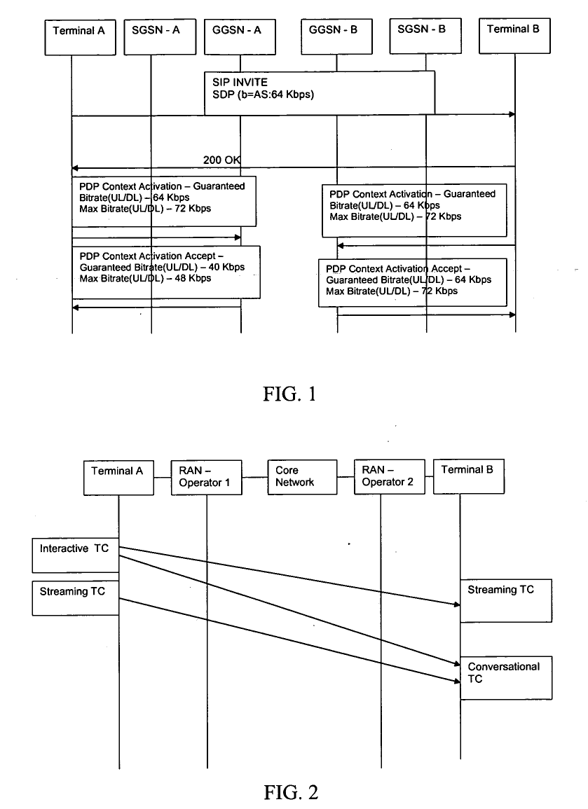

### DETAILED DESCRIPTION OF EXEMPLARY EMBODIMENTS

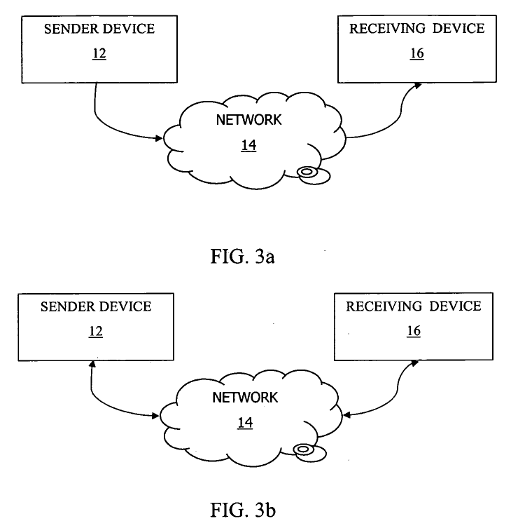

FIGS. 3a and b illustrate communication systems 10 in which a sender device 12 communicates via a network 14 to a receiving device 16. The sender device 12 can be for example a 3G cell phone, a handheld personal digital assistant, or some other device capable of multimedia communications. The network 14 can be any of a variety of networks capable of handling Internet Protocol (IP) communications. The receiving device 16 is a called party in that it is the device with whom sender device 12 communicates.

According to exemplary embodiments described herein, systems and methods enable the receiving device 16 and its wireless network to set up resources optimally and efficiently. The sender device 12 signals some of the negotiated QoS parameters to the receiving device 16 of the session during the session set up procedure. A multimedia session can be uni-directional or bi-directional. A uni-directional session can be a SWIS application and a bi-directional session can be a video conference application. If the session is bi-directional, in addition the receiving device 16 signals the QoS parameters to the sender device 12.

The guaranteed bitrate, maximum bitrate, and transfer delay (which are negotiated along with other QoS parameters during PDP context activation) are signaled to the receiving device 16. According to exemplary embodiments, new Session Description Protocol (SDP) attributes are defined for the above-mentioned QoS parameters, which are carried in Session Initiation Protocol (SIP) messages. The receiving device 16 can use these SDP attributes to negotiate (or renegotiate) QoS parameters with its own wireless network during PDP context activation. The receiving device 16 can use these parameters to set resources accordingly, such as jitter buffers for media such as audio and video.

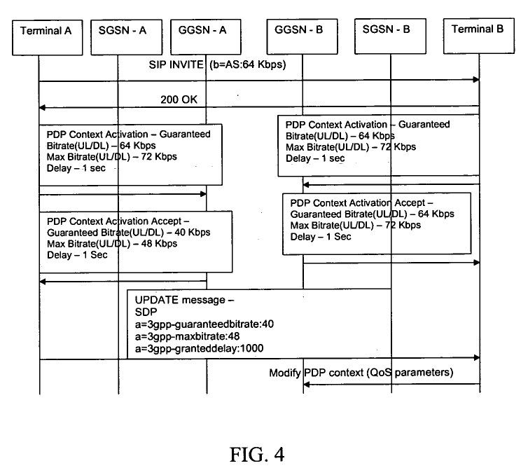

FIG. 4 illustrates signaling call flows with QoS SDP attributes in accordance with exemplary embodiments. Session Initiation Protocol (SIP) is a signaling protocol for session set up. The SIP INVITE message, which is used to set up a session between two parties, uses Session Description Protocol (SDP) to describe the session and media information. The SDP information can be sent in the body of other SIP messages such as 200 OK, ACK or UPDATE. Besides the transport information (port and IP address), the SDP includes media information (e.g., the codec and its parameters).

When Terminal A receives a 200 OK (PRACK) message from Terminal B, Terminal A initiates the PDP context activation procedure. Terminal A requests certain QoS parameters including maximum bitrate, guaranteed bitrate and transfer delay. The GGSN responds back to Terminal A with the network granted QoS parameters. Similarly, Terminal B initiates the PDP context activation procedure and requests QoS from the network.

In accordance with an exemplary embodiment, an attribute called “3gpp-guaranteedbitrate” is defined in SDP which indicates the guaranteed bandwidth which the receiving device negotiated with its wireless network. The 3gpp-guaranteedbitrate can be declared in SDP as “a=3gpp-guaranteedbitrate:<value>” where “value” denotes the guaranteed bit rate in kilobits per second (or any other suitable unit) allocated by the network to the receiving device for that session.

In accordance with an exemplary embodiment, an attribute called “3gpp-maxbitrate” is defined in SDP which indicates the maximum bit rate which the receiving device negotiated with its wireless network. The 3gpp-maxbitrate can be declared in SDP as “a=3gpp-maxbitrate:<value>” where value denotes the maximum bit rate in kilobits per second (or any other suitable unit) allocated by the network to the receiving device for that session.

In accordance with an exemplary embodiment, an attribute called “3gpp-granteddelay” can be defined in SDP, which indicate the transfer delay value the sender has negotiated with the wireless network. The delay attribute can be declared in SDP as “a=3gpp-granteddelay:<delay-value>”. The delay-value is the delay in milliseconds (or any other suitable in the time or space domain), which the sender device wants to use during the session.

By way of example, the 3gpp-granteddelay SDP attribute can also be assigned values of * and 0. A value of * specifies that the delay value is unknown and is unbounded meaning there is no guarantee on the delay values and the packets can experience different amount of transfer delays. For interactive and background traffic classes, the UMTS network does not assign any PDP context transfer delay value which implies its unbounded or best effort depending on the network resources and load. In that case, the SDP attribute can be assigned a value of * or 0.

One or more of the above defined attributes can be included in the SDP (which can be sent either in the UPDATE, 200 OK, or ACK message). The QoS parameters defined here cannot be included in the initial SIP INVITE message (sent to start a new session). In 3GPP IMS (IP Multimedia Subsystem) calls, the QoS parameters are negotiated only after the sender sends a initial INVITE message and receives a response from the other party indicating its willingness to participate in the multimedia session.

When Terminal A receives the PDP context activation accepted message from the network, Terminal A sends a SIP UPDATE message signaling the QoS parameters defined herein. Other parameters are preferably signaled, too. On receiving an UPDATE message, Terminal B modifies the PDP context. For a bi-directional call, Terminal B can also signal the granted QoS parameters to Terminal A. In case the receiver of the SDP doesn't understand the QoS attributes defined above it can ignore the attribute without any negative effect to the session set up procedure.

The exemplary embodiments have the advantage of signaling the guaranteed and maximum bitrate end-to-end such that the receiver (and the sender) network can set up the network resources (radio and core network) optimally and efficiently. Further, the exemplary embodiments provide good perceived media quality and media codecs can be initialized using the information communicated by the devices.

Advantageously, signaling the delay requirement allows the receiver side to set up resources and request exact parameters from its network. For example, the receiver side can set up memory buffer values. In multimedia applications such as streaming or SWIS, the receiving device benefits from establishing its resources. For instance, for applications like video conferencing, the signaling of delay requirements are useful since the called party of the session can request precise delay requirements for the session. For non-IMS SIP networks, the delay requirements can be set by the sender to a known default values for particular applications. Further advantages of the exemplary embodiments include that the QoS parameters can be signaled end-to-end in bi-directional mode. Further, additional QoS parameters are defined in terms of SDP.

While several embodiments of the invention have been described, it is to be understood that modifications and changes will occur to those skilled in the art to which the invention pertains. For example, it should be understood that SDP and SIP are example protocols. The information between the parties can be transferred using any protocol message at any layer of the ISO OSI (International Standards Organization, Open System Interconnection) stack. Accordingly, the claims appended to this specification are intended to define the invention precisely.

1. A method of signaling quality of service parameters for a multimedia session, the method comprising:
communicating quality of service parameters from a sending device to a receiving device at the creation of a multimedia session;
negotiating parameters by the receiving device with a network associated with the receiving device, wherein the negotiated parameters are based on the communicated quality of service parameters from the sending device; and
communicating quality of service parameters from the receiving device to the sending device during the multimedia session.

2. The method of claim 1, wherein the quality of service parameters comprise one or more of guaranteed bitrate, maximum bitrate, and transfer delay.

3. The method of claim 1, further comprising establishing resources at the receiving device based on the quality of service parameters.

4. The method of claim 3, wherein the resources comprise jitter buffers and media encoding parameters.

5. The method of claim 1, wherein the quality of service parameters comprise session description protocol parameters.

6. The method of claim 1, wherein the multimedia session is bi-directional.

7. A system for signaling quality of service parameters for a multimedia session, the system comprising:
means for communicating quality of service parameters from a sending device to a receiving device at the creation of a multimedia session;
means for negotiating parameters by the receiving device with a network associated with the receiving device, wherein the negotiated parameters are based on the communicated quality of service parameters from the sending device; and
means for communicating quality of service parameters from the receiving device to the sending device during the multimedia session.

8. The system of claim 7, wherein the multimedia session is bi-directional.

9. The system of claim 7, wherein the quality of service parameters comprise one or more of guaranteed bitrate, maximum bitrate, and transfer delay.

10. The system of claim 7, further comprising means for establishing resources at the receiving device based on the quality of service parameters.

11. A system for signaling quality of service parameters for a multimedia session, the system comprising:
a sending device that initiates a multimedia session and communicates quality of service parameters via a communication network; and
a receiving device that receives the communicated quality of service parameters, negotiates parameters with a wireless network associated with the receiving device, and communicates quality of service parameters to the sending device.

12. The system of claim 11, wherein the quality of service parameters comprise one or more of guaranteed bitrate, maximum bitrate, and transfer delay.

13. The system of claim 11, wherein the receiving deice establishes resources based on the quality of service parameters.

14. A computer program product utilized in data encoding comprising:
computer code to communicate quality of service parameters from a sending device to a receiving device at the creation of a multimedia session;
computer code to negotiate parameters by the receiving device with a network associated with the receiving device, wherein the negotiated parameters are based on the communicated quality of service parameters from the sending device; and
computer code to communicate quality of service parameters from the receiving device to the sending device during the multimedia session.

15. The computer program product of claim 14, wherein the quality of service parameters comprise any one of guaranteed bitrate, maximum bitrate, and transfer delay.

16. A device that communicates in multimedia sessions over a network, the device comprising:
memory that stores quality of service parameters which are communicated to a receiving device at a start of a multimedia session; and
a processor that receives granted parameters from the receiving device and enables multimedia communication in accordance with the granted parameters.

17. The device of claim 16, wherein the quality of service parameters comprise any one of guaranteed bitrate, maximum bitrate, and transfer delay.

18. A device that communicates in multimedia sessions over a network, the device comprising:
a processor that negotiates parameters with an associated network based on quality of service parameters received from a sending device; and
programmed instructions that establish resources based on the quality of service parameters received from the sending device.

19. The device of claim 18, wherein the quality of service parameters comprise any one of guaranteed bitrate, maximum bitrate, and transfer delay.

20. The device of claim 18, wherein the processor communicates the negotiated parameters the sending device.
